(19) United States
(12) Patent Application Publication
(10) Pub. No.: US 2021/0123283 A1
(43) Pub. Date: Apr. 29, 2021

(54) ANIMAL ENCLOSURE SAFE DOOR SYSTEM AND METHOD

(71) Applicant: Chad Sutterer, Perryville, MO (US)

(72) Inventor: Chad Sutterer, Perryville, MO (US)

(21) Appl. No.: 16/662,454

(22) Filed: Oct. 24, 2019

(51) Int. Cl. E05F 15/40; A01K 1/08; A01K 31/02; E05F 15/70; E05F 15/60

(52) U.S. Cl. CPC E05F 15/40; A01K 1/08; A01K 31/02; E05F 15/70; E05Y 2400/858; E05Y 2201/434; E05Y 2400/52; E05Y 2400/44; E05Y 2900/40; E05F 15/60

(57) ABSTRACT

An animal enclosure safe door system may include a door which may be moved between an open position and a closed position via an actuator. A controller unit may operate the actuator to move the door between the open and closed position. The controller unit may comprise a sensor engine which may be configured to detect the presence of an obstruction object which may prevent the door from moving into the closed position. If an obstruction object is detected, the controller unit may stop and/or reverse the movement of the door. A method of an animal enclosure safe door system may include: motivating the door from an open position into the closed position; detecting the presence of an obstruction object in the path of the door to the closed position; stopping the movement of the door for a period of time; and motivating the door into the closed position.

### FIELD OF THE INVENTION

This patent specification relates to the field of systems and methods for controlling access to animal enclosures. More specifically, this patent specification relates to a system and method for controlling access to animal enclosures that also prevents inadvertent injury to animals, including humans, and damage to physical components of the device.

### BACKGROUND

Access to animal enclosures, such as chicken coops, goat pens, and the like, is enabled through the used of various types of doors. A new development in this field is the use of automated doors which are able to open and/or close automatically without human intervention. There are several manufacturers that provide door devices that use an actuator to close and/or open a door which controls access to animal enclosures. However, these devices do not provide safety features which prevent animals and other objects from being caught or crushed in the door. With the products that exist in the market, the controller starts the actuator to close the door. If a chicken or anything else obstructs the doorway, the actuator will keep pressing the door closed until the actuator reaches full extension or the actuator breaks. This has killed many animals, such as chickens, by crushing them with the actuator and door. Even more alarming, if a child was in the way, it could do the same to them as the actuators used are very powerful.

Therefore, a need exists for novel systems and methods for controlling access to animal enclosures. A further need exists for novel systems and methods for controlling access to animal enclosures that also prevent inadvertent injury to animals, including humans, and damage to physical components of the devices.

### BRIEF SUMMARY OF THE INVENTION

According to one aspect consistent with the principles of the invention, a computer implemented animal enclosure safe door system is provided. The system may be coupled to or comprise an animal enclosure, such as a chicken coop, goat enclosure, pig pen, etc. In some embodiments, the system may include: a door movable between an open position and a closed position; an actuator operable to motivate the door between the open position and the closed position; a computing platform having a processor, a memory in communication with the processor; actuator logic stored in the memory, executable by the processor and configured to operate the actuator to move the door between the open position and the closed position; and sensor logic stored in the memory, executable by the processor and configured to detect an obstruction object in the path of the door to the closed position. The sensor logic may communicate with the actuator engine to stop the door movement for a period of time when an obstruction object in the path of the door to the closed position is detected.

According to another aspect consistent with the principles of the invention, a computer implemented method for moving a door of an animal enclosure safe door system safely into a closed position is provided. In some embodiments, the method may include the steps of: motivating the door from an open position into the closed position, via an actuator operated by an actuator engine of a controller unit; detecting the presence of an obstruction object in the path of the door to the closed position, via a sensor engine of the controller unit; stopping the movement of the door for a period of time, via the actuator engine and a timer engine of the controller unit; and motivating the door into the closed position via the actuator engine of the controller unit.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an animal enclosure safe door system according to various embodiments described herein.

FIG. 2A illustrates a perspective view of an example of an animal enclosure safe door system having a door in an open position according to various embodiments described herein.

FIG. 2B shows a perspective view of an example of an animal enclosure safe door system having a door in a closed position according to various embodiments described herein.

FIG. 3 depicts a block diagram of some exemplary components of an example of an animal enclosure safe door system according to various embodiments described herein.

FIG. 4 illustrates a block diagram illustrating some applications of an animal enclosure safe door system which may function as software rules engines according to various embodiments described herein.

FIG. 5 shows a block diagram of an example of a computer-implemented method for moving a door safely into a closed position according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

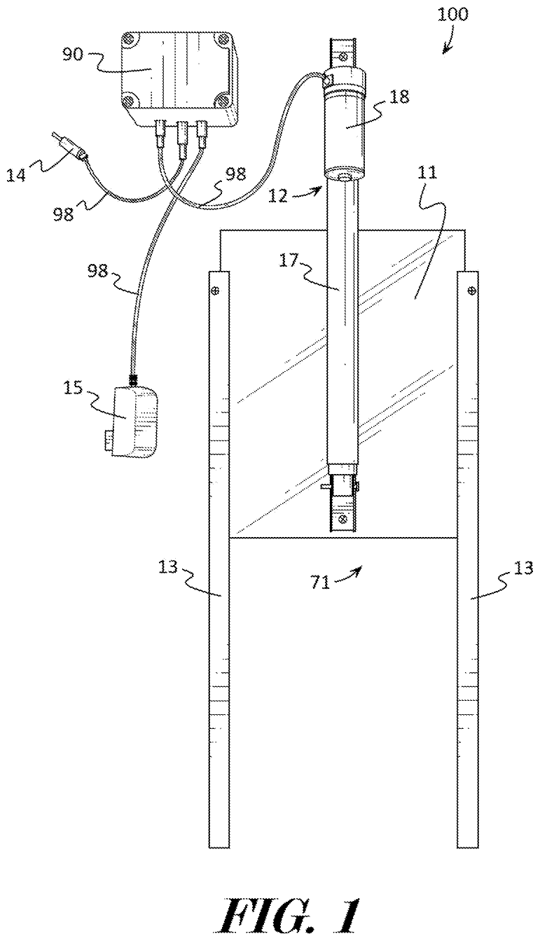

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new animal enclosure safe door system and method is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

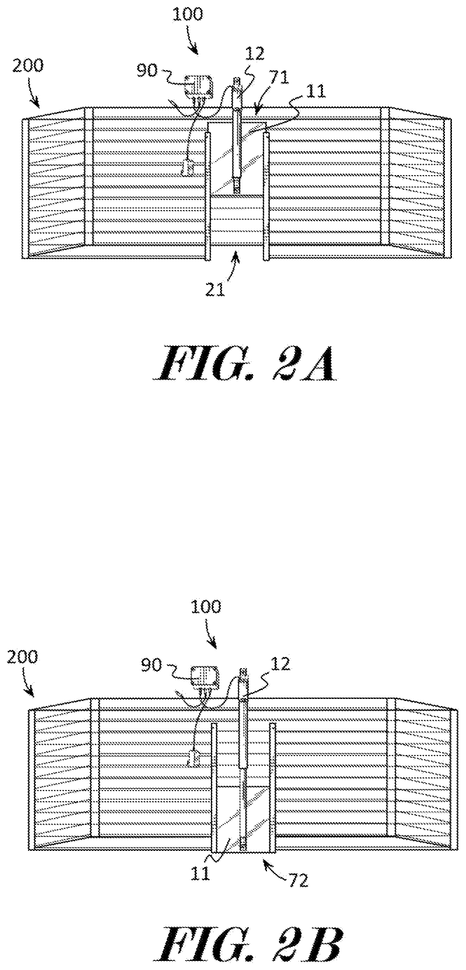

The present invention will now be described by example and through referencing the appended figures representing preferred and alternative embodiments. FIGS. 1-2A illustrate perspective views of some exemplary components of an example of an animal enclosure safe door system (“the system”) 100 according to various embodiments. In some embodiments, the system 100 may comprise a door 11 which may be moved between an open position 71 and a closed position 72 via an actuator 12. When in the open position 71 the door 11 may allow access to an opening 21 which may allow animals and other objects to enter and exit an animal enclosure 200 that the system 100 may be coupled to. When in the closed position 72 the door 11 may block access to the opening 21 to prevent animals and other objects from entering and exiting the animal enclosure 200 that the system 100 may be coupled to. The actuator 12 may be in communication with a controller unit 90, and the controller unit 90 may operate the actuator 12 to move the door 11 between the open position 71 and closed position 72. The controller unit 90 may comprise a sensor engine 97B which may be configured to detect the presence of an obstruction object, such as a chicken, human, other animal, or object, which may hinder or prevent the door 11 from moving into the closed position 72. If an obstruction object is detected during movement of the door 11 into the closed position 72, the controller unit 90 may stop and/or reverse the movement of the door 11.

Generally, the system 100 may comprise one or more doors 11 which may be coupled to an animal enclosure 200 or other structure, and the door(s) 11 may be moved between an open position 71 and a closed position 72. When in the open position 71 the door 11 may allow access to an opening 21 which may allow animals and other objects to enter and exit an animal enclosure 200 that the system 100 may be coupled to. When in the closed position 72 the door 11 may block access to the opening 21 to prevent animals and other objects from entering and exiting the animal enclosure 200 that the system 100 may be coupled to. A door 11 may be configured in any shape and size. In some embodiments, a door 11 may be generally rectangular in shape having a height of between approximately 5.0 inches and 36 inches and a width of between approximately 5.0 inches and 24 inches.

In some embodiments, a door 11 may be moved between the positions 71, 72, by being raised and lowered vertically. For example, the door 11 may be positioned between one or more rails 13 which may be coupled to an animal enclosure 200 and which may guide the vertical movement of the door 11 and also maintain the door 11 in the positions 71, 72. In further embodiments, a door 11 may be moved between the positions 71, 72, by being moved horizontally. For example, the door 11 may be positioned between one or more rails 13 which may guide the horizontal movement of the door 11 and also maintain the door 11 in the positions 71, 72. In still further embodiments, a door 11 may be moved between the positions 71, 72, by being pivoted horizontally or vertically. For example, the door 11 may be pivotally coupled to a rail 13 via a hinge which may guide the pivoting movement of the door 11 and also maintain the door 11 in the positions 71, 72. In alternative embodiments, a door 11 may be moved between an open position 71 and a closed position 72 by any other type or direction of movement, such as which may be used by rotating doors, other types of sliding doors, etc. Preferably, a door 11 and rails 13 may be made from or may comprise aluminum, other metals and alloys, hard plastic, carbon fiber, wood, or any other substantially rigid material(s).

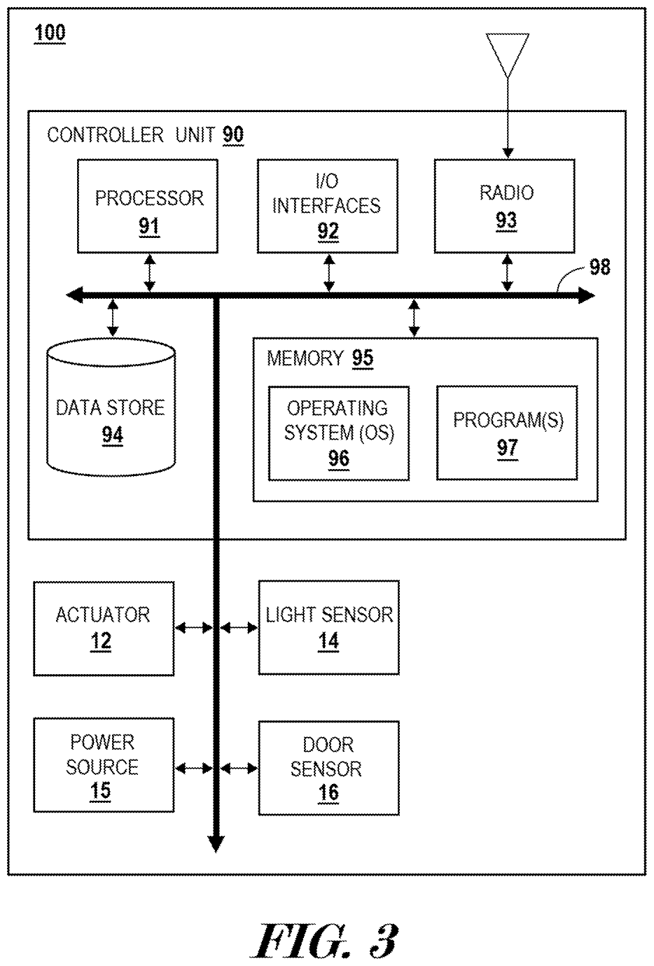

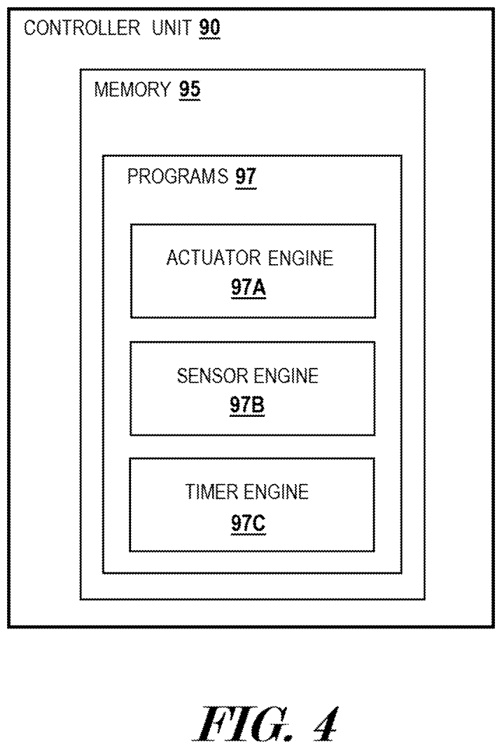

FIG. 3 depicts a block diagram illustrating some exemplary components that a system 100 may comprise. In some embodiments, the controller unit 90 can be a digital device that, in terms of hardware architecture, may optionally comprise a dedicated processor 91 and which may function as a computing platform. It should be appreciated by those of ordinary skill in the art that FIG. 3 depicts an example of a controller unit 90 in an oversimplified manner, and a practical embodiment may include additional components or elements and suitably configured processing logic to support known or conventional operating features that are not described in detail herein.

A local interface 98 may provide electronic communication between one or more components (91, 92, 93, 94, 95) of the controller unit 90 and/or other components (12, 14, 15) of the system 100. In some embodiments, a local interface 98 may be an integrated circuit (IC) that integrates one or more components, (90, 92, 93, 94, and 95) on a single chip sometimes called a system on a chip (SoC) or (SOC). In further preferred embodiments, a local interface 98 and one or more components (90, 92, 93, 94, and 95) may be a microcontroller (or MCU, short for microcontroller unit) which may be a small computer (SoC) on a single integrated circuit containing a processor 91, memory 95, and programmable input/output interfaces or peripherals 92. Program memory in the form of Ferroelectric RAM, NOR flash or OTP ROM is also often included on chip, as well as a typically small amount of RAM. Microcontrollers are designed for embedded applications, in contrast to the microprocessors used in personal computers or other general-purpose applications consisting of various discrete chips. Microcontrollers are used in automatically controlled products and devices, such as automobile engine control systems, implantable medical devices, remote controls, office machines, appliances, power tools, toys and other embedded systems. By reducing the size and cost compared to a design that uses a separate microprocessor, memory, and input/output devices, microcontrollers make it economical to digitally control even more devices and processes. Mixed signal microcontrollers are common, integrating analog components needed to control non-digital electronic systems.

In alternative embodiments, a local interface 98 may comprise a printed circuit board (PCB) which mechanically supports and electrically connects electronic components including MCU's using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In further embodiments, a local interface 98 may comprise a printed circuit assembly (PCA), printed circuit board assembly or PCB assembly (PCBA), a circuit card assembly (CCA), or a backplane assembly, or any other suitable electrical connection and communication method including standard wiring and the like.

In still further alternative embodiments, a local interface 98 can be, for example but not limited to, one or more buses or other wired or wireless connections, as is known in the art. The local interface 98 can have additional elements, which are omitted for simplicity, such as controllers, buffers (caches), drivers, repeaters, and receivers, among many others, to enable communications. Further, the local interface 98 may include address, control, and/or data connections to enable appropriate communications among the aforementioned components.

In some embodiments, a controller unit 90 may comprise one or more processors 91, I/O interfaces 92, radio modules 93, data stores 94, and/or memory 95. The processor 91 is a hardware device for executing software instructions. The processor 91 can be any custom made or commercially available processor, a central processing unit (CPU), an auxiliary processor among several processors, a semiconductor-based microprocessor (in the form of a microchip or chip set), or generally any device for executing software instructions. When in operation, the processor 91 is configured to execute software stored within the memory 95, to communicate data to and from the memory 95, and to generally control operations of the system 100 pursuant to the software instructions. In an exemplary embodiment, the processor 91 may include a mobile optimized processor such as optimized for power consumption and mobile applications.

The I/O interfaces 92 can be used to input and/or output information and power. In some embodiments, I/O interfaces 92 may include one or more turnable control knobs, depressible button type switches, a key pad, slide type switches, dip switches, rocker type switches, rotary dial switches, numeric input switches or any other suitable input which a user may interact with to provide input. In further embodiments, I/O interfaces 92 may include one or more light emitting elements or other display device, e.g., a LED (light emitting diodes), a speaker, or any other suitable device for outputting or displaying information. The I/O interfaces 92 can also include, for example, a serial port, a parallel port, a small computer system interface (SCSI), an infrared (IR) interface, a radio frequency (RF) interface, a universal serial bus (USB) interface, and the like.

An optional radio module 93 may enable wireless communication to an external access device or network through an antenna. A radio module 93 may comprise a wireless communication receiver and optionally a wireless communication transmitter. In some embodiments, a radio module 93 may operate on a cellular band and may communicate with or receive a Subscriber Identity Module (SIM) card or other wireless network identifier. Any number of suitable wireless data communication protocols, techniques, or methodologies can be supported by the radio module 93, including, without limitation: RF; IrDA (infrared); Bluetooth; ZigBee (and other variants of the IEEE 802.15 protocol); IEEE 802.11 (any variation such as WiFi); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 94 may be used to store data. The data store 94 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 94 may incorporate electronic, magnetic, optical, and/or other types of storage media.

The memory 95 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 95 may incorporate electronic, magnetic, optical, and/or other types of storage media. Note that the memory 95 may have a distributed architecture, where various components are situated remotely from one another, but can be accessed by the processor 92. The software in memory 95 can include one or more software programs, each of which includes an ordered listing of executable instructions for implementing logical functions. In the example of FIG. 3, the software in the memory system 95 may include a suitable operating system (O/S) 96 and programs 97. An operating system 96 essentially controls the execution of input/output interface 92 functions, and provides scheduling, input-output control, file and data management, memory management, and communication control and related services. The operating system 96 may be, for example, LINUX (or another UNIX variant) and any Linux-kernel-based operating systems, Raspbian, Ubuntu, OpenELEC, RISC OS, Arch Linux ARM, OSMC (formerly Raspbmc) and the Kodi open source digital media center, Pidora (Fedora Remix), Puppy Linux, Android (available from Google), Symbian OS, Microsoft Windows CE, Microsoft Windows 10 Mobile, other Microsoft Windows versions, iOS (available from Apple, Inc.), webOS (available from Hewlett Packard), Blackberry OS (Available from Research in Motion), and the like.

The programs 97 may include various applications, add-ons, etc. configured to provide end user functionality such as to control the operation of functions of actuators 12, light sensors 14, power sources 15, door sensor 16, and/or any other component of the system 100. In some embodiments, the programs 97 may include an actuator engine 97A, a sensor engine 97B, and a timer engine 97C. It should be understood that the functions attributed to the engines 97A, 97B, 97C, described herein are exemplary in nature, and that in alternative embodiments, any function attributed to any engine 97A, 97B, 97C, may be performed by one or more other engines 97A, 97B, 97C, or any other suitable processor logic.

In some embodiments, the system 100 may comprise an actuator engine 97A. An actuator engine 97A may comprise or function as actuator logic stored in a memory 95 which may be executable by the processor 91. Generally, an actuator engine 97A may provide a signal to the actuator(s) 12 which may cause the actuator(s) 12 to motivate the door 11 into, out of, and between the open 71 and closed 72 positions. The system 100 may comprise one or more actuators 12 which may be configured to physically move the door(s) 11 between the open 71 and closed 72 positions. Typical actuators require a control signal and a source of energy. The control signal may be relatively low energy and may be electric voltage or current, pneumatic or hydraulic pressure, or even human power. The supplied main energy source may be electric current, hydraulic fluid pressure, or pneumatic pressure. When a control signal is received from the controller unit 90, such as from an actuator engine 97A, the actuator 12 responds by converting the energy into mechanical motion. An actuator 12 is the mechanism by which a controller unit 90 effects door 11 movement and may comprise any type of comb drive, digital micromirror device, solenoid, electric motor, electroactive polymer, hydraulic cylinder, piezoelectric actuator, pneumatic actuator, servomechanism, thermal bimorph, screw jack, or any other type of hydraulic, pneumatic, electric, mechanical, thermal, magnetic type of actuator, or any other type of actuator.

In some embodiments, the actuator 12 may comprise an electric motor 18 that may be configured to convert electrical energy into mechanical energy to motivate the door 11 between the open 71 and closed 72 positions. In preferred embodiments, an actuator 12 may comprise a linear actuator arm 17 that may be powered by an electric motor 18. A motor 40 may comprise a brushed DC motor, brushless DC motor, switched reluctance motor, universal motor, AC polyphase squirrel-cage or wound-rotor induction motor, AC SCIM split-phase capacitor-start motor, AC SCIM split-phase capacitor-run motor, AC SCIM split-phase auxiliary start winding motor, AC induction shaded-pole motor, wound-rotor synchronous motor, hysteresis motor, synchronous reluctance motor, pancake or axial rotor motor, stepper motor, or any other type of electrically operated motor. In further embodiments, a motor 18 may comprise a hydraulic motor such as a Gear and vane motor, Gerotor motor, Axial plunger motors, Radial piston motors, or any other hydraulically motivated motor. In still further embodiments, a motor 18 may comprise a pneumatic motor, such as a linear pneumatic motor and a pneumatic rotary vane motor.

In some embodiments, the system 100 may comprise a sensor engine 97B. A sensor engine 97B may comprise or function as sensor logic stored in a memory 95 which may be executable by the processor 91. Generally, a sensor engine 97B may be configured to detect the presence of an obstruction object which may hinder or prevent the door 11 from moving into the closed position 72. If an obstruction object is detected during movement of the door 11 into the closed position 72, the sensor engine 97B may electronically communicate with the actuator engine 97A so that the actuator engine 97A may stop, reverse the movement of the door 11, and/or move the door 11 into the open position 71.

In some embodiments, a sensor engine 97B may monitor force used by an actuator 12 during the closing of the door 11. If the force or current is greater than a setpoint force or current, the sensor engine 97B may electronically communicate with the actuator engine 97A to halt actuator 12 movement in the current direction (optionally for a period of time), reverse the door 11 direction (optionally for a period of time), and/or then proceed to continue door 11 movement in the original direction. The monitoring of force allows the obstruction object or obstructing body to not be crushed by the actuator 12 and door 11 and protects the actuator 12 and door 11 from being damaged by contacting obstruction objects. Preferably, a sensor engine 97B may monitor the force exerted by an actuator 12 in moving the door 11. For example, a sensor engine 97B may uses a feedback monitoring mechanism to monitor how much current is being applied to the actuator 12. The amount of force may be calculated by monitoring the amount of current (Amperes) that is being delivered to the actuator 12. Preferably, the system 100 may comprise a cutoff setpoint force or setpoint current that may optionally be selectable by a user via an I/O interface 92. Optionally, the system 100 may also include a setting to turn the feature off If the force or current is greater than the setpoint force or current during door 11/actuator 12 movement, the sensor engine 97B may electronically communicate with the actuator engine 97A to halt actuator 12 movement in the current direction (optionally for a period of time), reverse the door 11 direction (optionally for a period of time), and/or then proceed to continue door 11 movement in the original direction.

In some embodiments, the system 100 may comprise a door sensor 16 which may be in communication with a sensor engine 97B. A door sensor 16 may comprise any type of sensor or device which may be able to detect the presence of an obstruction object in the path of a door 11 and/or the presence of an obstruction object proximate to the door 11, and the door sensor 16 may communicate this data to the sensor engine 97B. Example door sensors 16 may include sensors such as fixed (single beam) or rotating (sweeping) Time-of-Flight (TOF) or structured light based laser rangefinders, 3D High Definition LiDAR, 3D Flash LIDAR, 2D or 3D sonar sensors and one or more 2D cameras, passive thermal infrared sensors, Photocell or reflective sensors, photoelectric, or ‘eye-beam’ sensors, Radar sensors, Reflection of ionizing radiation sensors, Sonar sensors, such as active or passive, Ultrasonic sensors, Fiber optics sensors, Hall effect sensors, or any other sensor able to detect the presence of objects and surfaces without any physical contact.

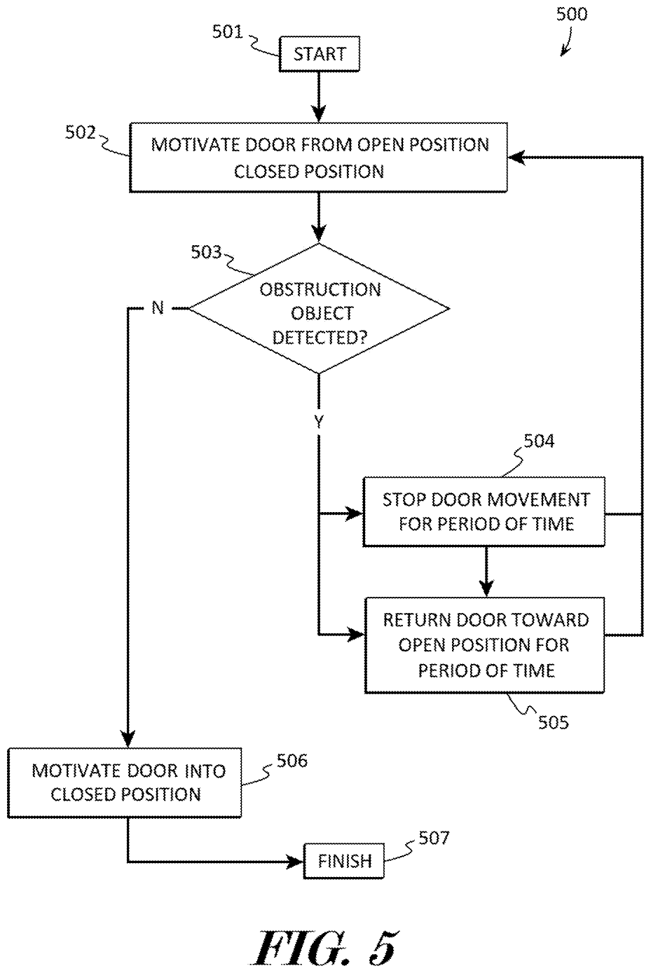

In some embodiments, the system 100 may comprise a timer engine 97C. A timer engine 97C may comprise or function as timer logic stored in a memory 95 which may be executable by the processor 91. Generally, a timer engine 97C may be configured to function as a digital clock and which may perform functions such as, providing the current date and time, operating as a countdown timer, etc. In preferred embodiments, a timer engine 97C may be configured to operate an actuator 12 (via communicating with an actuator engine 97A) to motivate a door 11 into, out of, and between the open 71 and closed 72 positions at one or more times or at the start or end of one or more time periods. For example, a timer engine 97C may be configured to operate an actuator 12 to move the door 11 into the open position 71 at 6 AM and to move the door 11 into the closed position 72 at 7 AM. In further embodiments, a timer engine 97C may be configured to count down the time in a time period, such as in step 504 (FIG. 5).

In some embodiments, the system 100 may comprise one or more light sensors 14 which may be in communication with the controller unit 90, such as in communication with an actuator engine 97A. Generally, a light sensor 14 may be configured to provide data describing ambient light levels proximate to one or more elements of the system 100. In some embodiments, a light sensor 14 may be coupled to a component of the system 100, such as to a door 11, actuator 12, or controller unit 90. In other embodiments, a light sensor 14 may be remote in nature, such as by being connected to the controller unit 90 via a length of electrical wire type local interface 98. Using the ambient light level data provided by a light sensor 14, an actuator engine 97A may be configured to motivate a door 11 into an open position 71 or a closed position 72. For example, when a light sensor 14 detects an ambient light level equal to or greater than the amount of light at dawn, the actuator engine 97A may motivate a door 11 into an open position 71. As another example, when a light sensor 14 detects an ambient light level equal to or less than the amount of light at dusk, the actuator engine 97A may motivate a door 11 into a closed position 72.

In preferred embodiments, a light sensor 14 may be or comprise a passive device that converts the light energy into an electrical signal output. Light sensors 14 are more commonly known as Photoelectric Devices or Photo Sensors because they convert light energy (photons) into electronic signal (electrons). A light sensor 14 may detect light levels via any suitable detection mechanism including: Photoemission or photoelectric effect; thermal; polarization; photochemical; and weak interaction effects. Example light sensors 14 include: Active-pixel sensors (APSs), Cadmium zinc telluride radiation detectors, Charge-coupled devices (CCD), HgCdTe infrared detectors, LEDs which are reverse-biased to act as photodiodes, Photoresistors or Light Dependent Resistors (LDR), Photodiodes which can operate in photovoltaic mode or photoconductive mode, Phototransistors, which act like amplifying photodiodes, Quantum dot photoconductors or photodiodes, and Photovoltaic cells or solar cells.

In some embodiments, the system 100 may comprise a power source 15 which may provide electrical power to any component of the system 100 that may require electrical power. In further embodiments, a power source 15 may comprise a battery, such as a lithium ion battery, nickel cadmium battery, alkaline battery, or any other suitable type of battery, a fuel cell, a capacitor, a super capacitor, or any other type of energy storing and/or electricity releasing device. In still further embodiments, a power source 15 may comprise a power cord, kinetic or piezo electric battery charging device, a solar cell or photovoltaic cell, and/or inductive charging or wireless power receiver.

FIG. 5 shows a block diagram of an example of a computer-implemented method for moving a door 11 safely into a closed position 72 (“the method”) 500 according to various embodiments described herein. In some embodiments, the method 500 may be used to motivate a door 11 that may be movably coupled to an animal enclosure 200 from an open position 71 into a closed position 72 while preventing damage to an obstruction object and/or the door 11. One or more steps of the method 500 may be performed by an actuator engine 97A, sensor engine 97B, and/or timer engine 97C which may be executed by a computing device processor, such as a processor 91 (FIG. 3).

The method 500 may start 501 and a door 11 of the system 100 may be motivated from an open position 71 to a closed position 72 in step 502. In some embodiments, an actuator engine 97A may provide a control signal to an actuator 12 which is operable to motivate the door 11 into the closed position 72. In further embodiments, step 502 may be initiated using ambient light level data provided by a light sensor 14.

In decision block 503, a sensor engine 97B of the system 100 may determine if an obstruction object is detected in the path of the door 11 to the closed position 72. An obstruction object may comprise all or portions of an animal, such as a chicken, goat, etc. all or portions of a human being, or all or portions of an inanimate object, such as a shovel, water bottle, food tray, etc., which may contact the door 11 during its movement into the closed position 72.

In some embodiments, a sensor engine 97B may determine if an obstruction object is detected by monitoring force or electrical current used by an actuator 12 during the closing of the door 11. If the force or current is greater than a setpoint force or current, the sensor engine 97B may determine that an obstruction object is detected. In further embodiments, the system 100 may comprise a door sensor 16 which may be in communication with a sensor engine 97B, and the sensor engine 97B may determine if an obstruction object is detected by data communicated to the sensor engine 97B by the door sensor 16. A door sensor 16 may comprise any type of sensor or device which may be able to detect the presence of an obstruction object in the path of a door 11 and/or the presence of an obstruction object proximate to the door 11, and the door sensor 16 may communicate this data to the sensor engine 97B.

If an obstruction object is not detected, the method 500 may proceed to step 506 in which the door 11 motivated into the closed position 72. If an obstruction object is detected, the method 500 may proceed to step 504 and/or 505.

In some embodiments, if an obstruction object is detected in decision block 503, the method 500 may continue to step 504 in which the movement of the door 11 into the closed position is stopped for a period of time. Preferably, the sensor engine 97B may communicate with the actuator engine 97A to stop the door 11 movement for a period of time as measured by a timer engine 97C. A period of time may comprise any length of time, but preferably a period of time may be approximately between 1.0 seconds and 60 seconds. In further embodiments, a period of time may be approximately between 0.1 seconds and 5.0 minutes. After step 504, the method 500 may continue to step 502 or to step 505.

In step 505, the door 11 may be returned toward the open position 72 for a period of time. Optionally, the period of time may be sufficient for the door 11 to be moved into or returned to the open position 71. Preferably, the sensor engine 97B may communicate with the actuator engine 97A to return the door 11 towards the open position 71 if an obstruction is detected in decision block 503 or after step 504. In preferred embodiments, the door 11 movement may be first stopped for a period of time as measured by a timer engine 97C when an obstruction object in the path of the door to the closed position is detected in step 504, and then the actuator engine 97A may motivate the door 11 towards the open position 71 for a period of time as measured by a timer engine 97C (in step 505) after the period of time in step 504 has ended.

After step 505, the method 500 may continue to step 502, and the method 500 may proceed until the door 11 is motivated into the closed position 72 in step 506, after which the method 500 may finish 507.

While some exemplary shapes and sizes have been provided for elements of the system 100, it should be understood to one of ordinary skill in the art that the door 11, actuator 12, rails 13, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the system 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the system 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the system 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the system 100 may be coupled by being one of connected to and integrally formed with another element of the system 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A computer implemented animal enclosure safe door system, the system comprising:
a door movable between an open position and a closed position;
an actuator operable to motivate the door between the open position and the closed position;
a computing platform having a processor, a memory in communication with the processor;
actuator logic stored in the memory, executable by the processor and configured to operate the actuator to move the door between the open position and the closed position; and
sensor logic stored in the memory, executable by the processor and configured to detect an obstruction object in the path of the door to the closed position, wherein the sensor logic communicates with the actuator engine to stop the door movement for a period of time when an obstruction object in the path of the door to the closed position is detected.

2. The system of claim 1, wherein the sensor logic communicates with the actuator engine to motivate the door into the open position after an obstruction object in the path of the door to the closed position is detected.

3. The system of 1, wherein the door movement is first stopped for a period of time when an obstruction object in the path of the door to the closed position is detected, and wherein the actuator engine motivates the door into the open position after the period of time has ended.

4. The system of claim 1, wherein the period of time is between 0.1 seconds and 5.0 minutes.

5. The system of claim 1, wherein the sensor engine detects the obstruction object by monitoring electrical current used by the actuator.

6. The system of claim 1, further comprising a door sensor, wherein the sensor engine detects the obstruction object by data communicated to the sensor engine by the door sensor.

7. The system of claim 6, wherein the door sensor comprises a photoelectric sensor.

8. The system of claim 1, further comprising a light sensor.

9. The system of claim 8, wherein the actuator logic motivates the door into the closed position and open position using ambient light level data provided by the light sensor.

10. The system of claim 1, further comprising a power source.

11. The system of claim 1, wherein the actuator comprises an electric motor.

12. A computer implemented method for moving a door of an animal enclosure safe door system safely into a closed position, the method comprising the steps of:
motivating the door from an open position into the closed position, via an actuator operated by an actuator engine of a controller unit;
detecting the presence of an obstruction object in the path of the door to the closed position, via a sensor engine of the controller unit;
stopping the movement of the door for a period of time, via the actuator engine and a timer engine of the controller unit; and
motivating the door into the closed position via the actuator engine of the controller unit.

13. The method of claim 12, further comprising the step of motivating the door into the open position that is performed after the step of stopping the movement of the door for a period of time.

14. The method of claim 12, wherein the period of time is between 0.1 seconds and 5.0 minutes.

15. The method of claim 12, wherein the step of detecting the presence of an obstruction object in the path of the door to the closed position is performed by a sensor engine of the system, and wherein the sensor engine detects the obstruction object by monitoring electrical current used by an actuator.

16. The method of claim 12, wherein the step of detecting the presence of an obstruction object in the path of the door to the closed position is performed by a door sensor that is in communication with a sensor engine of the system.

17. The method of claim 16, wherein the door sensor comprises a photoelectric sensor.

18. The method of claim 12, wherein motivating the door from an open position into the closed position is initiated using ambient light level data provided by a light sensor.

19. The method of claim 12, wherein the door is motivated from the open position into the closed position via an actuator.

20. The method of claim 19, wherein the actuator comprises an electric motor.
